(19) United States
(12) Patent Application Publication
(10) Pub. No.: US 2007/0000741 A1
(43) Pub. Date: Jan. 4, 2007

(54) Axial rotary eddy current brake with adjustable braking force

(76) Inventors: Edward M. Pribonic, Seal Beach, CA (US); Marc T. Thompson, Harvard, MA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/476,538

(22) Filed: Jun. 28, 2006

Related U.S. Application Data
(60) Provisional application No. 60/695,708, filed on Jun. 30, 2005.

(51) Int. Cl. B60L 7/10

(52) U.S. Cl. 188/267; 188/159

(57) ABSTRACT

The present invention relates to an axial adjustable, rotary brake device using eddy current resistance, having an annular rotating conductive reaction member fastened on a central axle, having a frame, and fitted with permanent magnets disposed on either one side or both sides of said member, wherein the magnets produce a magnetic field between the magnet arrays, and through the member. Relative motion of the member and magnets produces eddy current resistance opposing the movement of the member. The magnets are mounted such that their respective positions relative to each other and thus to the intermediate conductive member can be changed by an adjusting Structure to increase or decrease the space between magnets and member, (air gap), distance from the rotational center or their relationship to each other. Various other configurations for changing the spatial relationship of magnets and members are presented which can be employed to produce many embodiments and variations of the present invention.

The present application claims priority from U.S. Ser. No. 60/695,708 filed Jun. 30, 2005 which is to be incorporated herewith in its entirety by this specific reference thereto.

This invention relates to industrial equipment such as drive systems, conveyors, lifting hoists, paper rollers, metal strip rolling mills, moving equipment, elevators, vehicles and the like and more particularly to an eddy current brake for providing a constant or variable torque for controlling the such equipment.

Rotary eddy current brakes have been employed in many industrial applications, such as brakes, power transmission, or damping systems. The main advantage of such brakes, with respect to traditional mechanical friction brakes, retarding devices or tensioners, is represented by the absence of friction and the associated replacement or failure of brake components.

Prior art rotary eddy current brakes are for the most part electromagnetic devices that generally have no resistance controlling mechanism. When a control system is utilized it is some version of voltage control to change the strength of the magnetic field via the coils. This type of mechanism becomes complex, costly and is susceptible to failure.

Rotary eddy current brakes which utilize permanent magnets have in the past, been very power limited, and have been used mostly on exercise equipment or small machinery. Force adjustment approaches have tended to focus on adding coils and electrical circuits to influence the fields of the permanent magnets. Again the problems mentioned above are introduced into the system.

Because of these and other limitations, previous permanent magnet rotary brakes (not utilizing an electric control apparatus), are capable of maintaining a constant torque at only one specific rotational speed. Each change in rotational speed produces a change in the torque output.

If a varying torque is required in response to a constant speed, varying the torque was not possible without utilizing an electric control apparatus to over ride the permanent magnets. Conversely, if a constant torque is required in response to a varying speed, that function was also not possible without utilizing an electrical control apparatus to over ride the permanent magnets.

The present invention provides a Structure to solve both of those circumstances and others.

### SUMMARY OF THE INVENTION

An adjustable rotary brake device in accordance with the present invention generally includes at least one rotatable conductive reaction member along with a plurality of permanent magnets disposed adjacent the member. Structure is provided for varying the magnetic coupling between the plurality of permanent magnets and the member in order to vary eddy current resistance opposing rotation of the disc. In this manner, the brake device provides a variable torque through a range of rotational speeds without an electrical control apparatus.

More particularly, the structure may include apparatus for moving the plurality of permanent magnets in a direction perpendicular to a plane of the member. Alternatively, the structure may include apparatus for moving the plurality of permanent magnets in a direction parallel to a plane of the member.

In another embodiment, the structure includes apparatus for moving the plurality of permanent magnets in a radial direction relative to a member rotational axis. A further embodiment in accordance with the present invention includes apparatus for rotatably adjusting the plurality of permanent magnets to cause magnetic fields, associated with each magnet, to be out of phase with one another.

Yet another embodiment of the present invention includes apparatus for radially adjusting the plurality of permanent magnets to cause magnetic fields, associated with each magnet to be out of phase with one another.

Further, in any of the embodiments of the present invention, the permanent magnets may be arranged in a Halbach array. In addition, the reaction member may be a bladed disk if air movement is desired in and around the device.

More particularly, the member may be comprised with concentric rings of different materials having different electrical conduction in order to alter the eddy current resistance and apparatus may be provided for moving the member in a direction perpendicular to a plane of the member. Alternatively, apparatus may be provided for moving the member in a direction parallel to a plane of the member.

In yet another embodiment of the present invention, an adjustable rotary brake device may include a rotatable conductive reaction member along with the first plurality of permanent magnets disposed adjacent one side of the member and a second plurality of permanent magnets disposed adjacent another side of the member. Structure is provided for varying magnetic coupling between the first and second plurality of permanent magnets in order to vary eddy current resistant opposing limitation of the member.

Multiple parallel rotatable conductive members may be provided with outside members having opposite sides. In this embodiment, a first plurality of permanent magnets is disposed adjacent one opposing side and a second plurality of permanent magnets is disposed adjacent another opposing side and the structure provides for varying the magnetic coupling between the first and second plurality of permanent magnets in order to vary eddy current resistant posing rotation of the members.

In still another embodiment the present invention provides for an adjustable rotary brake device which includes at least one rotatable conductive reaction member. A plurality of permanent magnets disposed adjacent to the member and rotatable about a member axis and structure is provided for varying magnetic coupling between the plurality of permanent magnets and the member in order to vary eddy current resistance opposing rotation of the permanent magnets.

### BRIEF DESCIRIPTION OF THE DRAWINGS

The advantages and features of the present invention will be better understood by the following description when considered in conjunction with the accompanying drawings, in which:

FIG. 1 is a perspective view of an eddy current brake in accordance with the present invention generally showing first and second spaced apart support structures and first and second linear arrays of permanent magnets along with a diamagnetic or non-magnetic member attached to a rotatable shaft;

FIG. 2a is a perspective view of a first linear array of permanent magnets disposed upon a first support structure;

FIG. 2b is a perspective view of a bladed diamagnetic or non-magnetic disk;

FIG. 3 is an elevation view of the brake shown in FIG. 1;

FIG. 4 shows radially moving magnet adjacent arrays mounted to a structure, having little or no separation distance so as to increase magnetic interaction between the arrays, maximizing the total magnetic field produced with the corresponding arrays of the opposing structure;

FIG. 4a shows radially moving magnet arrays spaced apart by a separation distance so as to prevent magnetic interaction between the arrays, minimizing the total magnetic field produced;

FIG. 5 is an enlarged view of another array of permanent magnets in accordance with the present invention generally including a container and a plurality of magnets disposed therein in a polygon arrangement as will be hereinafter described in greater detail;

FIG. 6 is an enlarged view of another array of permanent magnets in accordance with the present invention generally depicting a plurality of magnets in a circular arrangement;

FIG. 7 illustrates magnet arrays which are slidably mounted to the structure and, moveable in a radial path from the center outwardly in this embodiment a variable braking force is produced by radially adjusting the position of the one or more magnet arrays based upon the principal that torque is generated in proportion to the distance of the force (arrays), from the fulcrum (shaft/rotational center).

FIG. 8 shows the magnet array of FIG. 7 radially displaced;

FIGS. 9 and 9a show the rotational off-set of radially shaped magnets for adjusting braking force by rotating corresponding magnets (on opposing structures 9 and 9a), out of magnetic alignment (phase) to each other, thus reducing magnetic field strength and subsequent braking power;

FIG. 10 shows another embodiment of the radially adjustable device utilizes at least two sets of concentric magnet arrays of any shape, in this embodiment, the outer set of arrays may be fixed at greater radial distance from the rotational center of the device than is the inner set of arrays, the outer and inner arrays maintain a separation between them such that they are not magnetically interactive, or are at least minimally interactive;

FIG. 10a illustrates the two rows of magnets as they have been moved radially into close proximity, or into contact with each other, thus producing a greatly increased magnetic field across a space;

FIGS. 11a and 11b depict the magnet arrays moveable along their long axis, for the purpose of varying alignment with the second group of arrays of on the second spaced apart structure;

FIG. 12 is a sectional view of an eddy current brake in accordance with the present invention generally depicting multiple spaced apart support structures containing multiple arrays of magnets, in this figure, the magnet arrays are depicted as circular arrays about the shaft, (as shown in FIGS. 7, 8 and 9), but may be of any configuration as suits the design requirements of the device, any number of structures, arrays or reaction members may be utilized;

FIG. 13 depicts an embodiment of the patent device where the Reactive member can be moved in the plane of the magnetic flux field, (while the structures and/or arrays remain in their original position), in order to vary the torque and braking force of the device alternate embodiments can be configured to reposition the member(s) via alternate Structure and through various directions such as laterally, pivoting, and the like;

FIG. 14 depicts an embodiment of the device where one or more of the structures and/or magnet arrays, can be moved in the plane of the magnetic flux field, (while the member(s) remain in their original position), in order to vary the torque and braking force of the device, other embodiments that can reposition the structures via alternate Structure and through various directions such as laterally, pivoting, and the like are to be considered with the scope of the present invention; and

FIGS. 15 and 15a depict an embodiment wherein the member is moved in an axial direction relative to magnet arrays.

### DETAILED DESCRIPTION

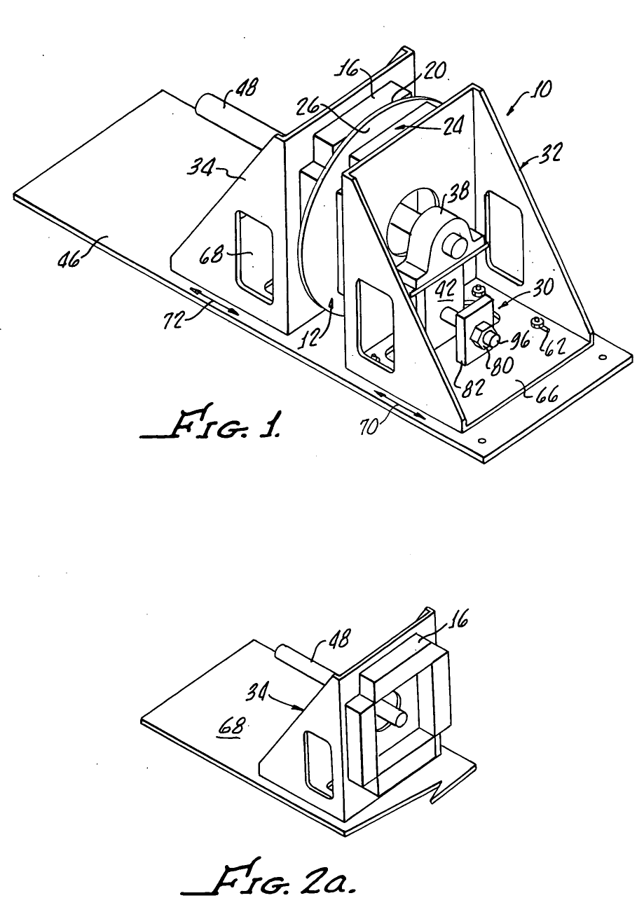

With referenced to FIGS. 1, 2a, 2b, and 3, there is shown an adjustable rotary brake device 10 generally including a rotatable conductive reaction member 12, a first plurality of permanent magnets 16 disposed adjacent to one side 20 of the member and a second plurality of permanent magnets 24. This row is adjacent to another side 26 of the member 12.

Structure 30 is provided for varying magnetic coupling between the first and second pluralities of magnets 16, 24 and the member 12 in order to vary eddy current resistance opposing rotation of the member.

More particularly the structure 30 includes movable frames 32, 34.

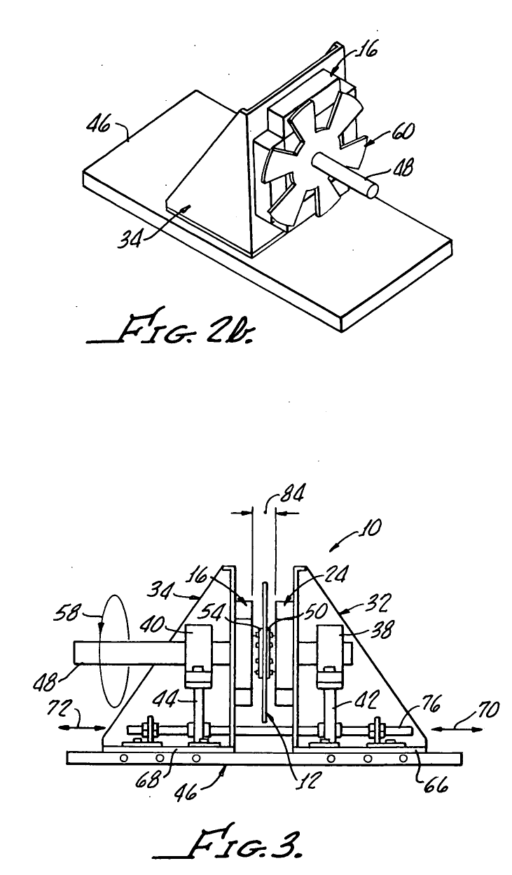

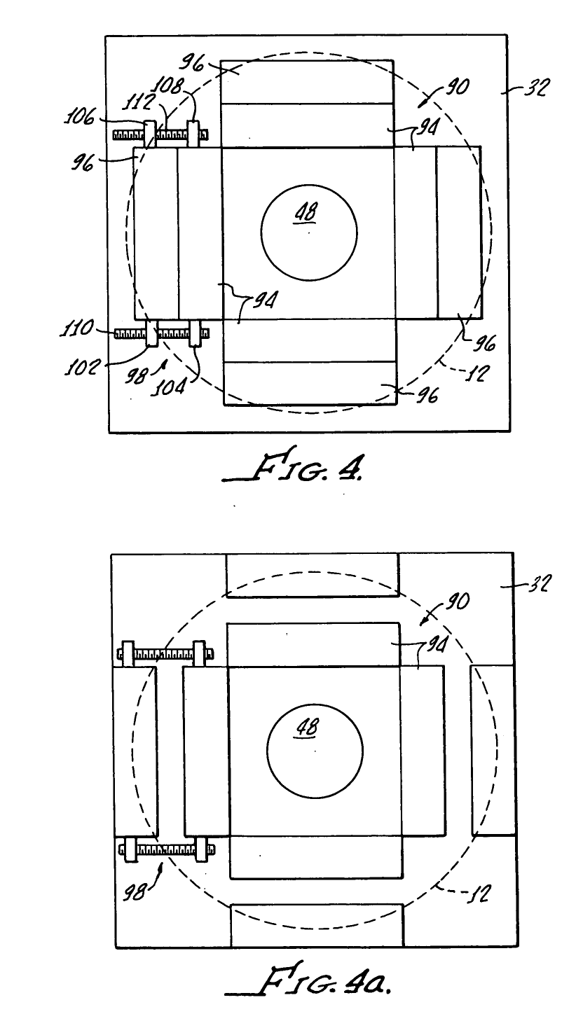

Bearings 38, 40 may be post 42 mounted to a base plate with the bearings 38, 40 rotatably supporting a shaft 48. As most clearly shown in FIG. 3, the member 12 is fixed to the shaft 48 for rotation therewith by hubs 52, 54 in a conventional manner, rotation of the member and shaft being indicated by the arrow 58. As shown in FIG. 2b, a bladed disk 60 may be utilized as the reaction member when air movement in and around the device is desired.

The structure 30 further includes slots 62 disposed in bases 66, 68 for enabling movement of the magnets 16, 24 in a direction perpendicular to a plane of the member as indicated by arrows 70, 72 in FIGS. 1 and 3. The movement as indicated by the arrows 70, 72 is provided by the structure 30 which may include a threaded bolt 76, and an adjusting nut 80. This adjustment varies a spacing, or gap, 84 between the magnets which varies the magnetic coupling between the plurality of permanent magnets 16, 24 and the member with concomitant variation in eddy current resistance opposing rotation of the member 12.

With reference to FIGS. 4 and 4a, there is shown an alternative magnet array embodiment 90 including an inner magnet array 94 and an outer magnet array 96. Structure 98 is provided for moving the permanent magnet 96 in a direction parallel to a plane of the member 12 as seen by a comparison of FIG. 4 and 4a. The structure may include threaded fittings 102, 104, 106, 108 fixed to arrays 94, 96 respectively and interconnected by threaded bolts 110, 112 respectively. Only one structure 98 is shown for sake of clarity.

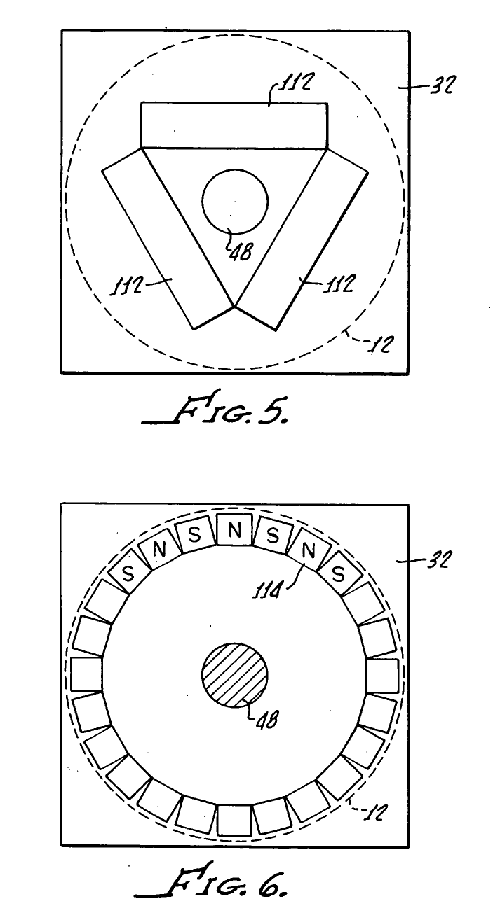

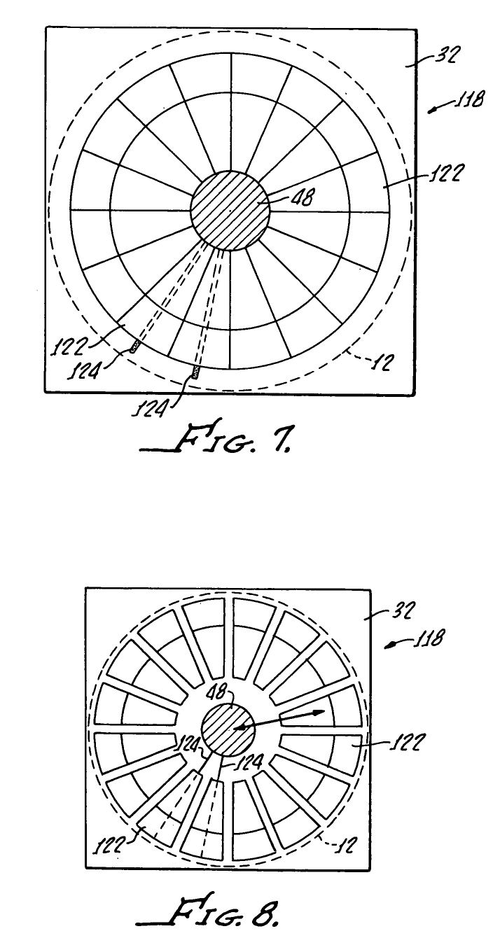

While the magnet arrays 16, 24 are rectilinear in this position, it should be appreciated that triangular magnet arrays are shown in FIG. 5 and circular magnet arrays 114, as shown in FIG. 6 respectively may be utilized.

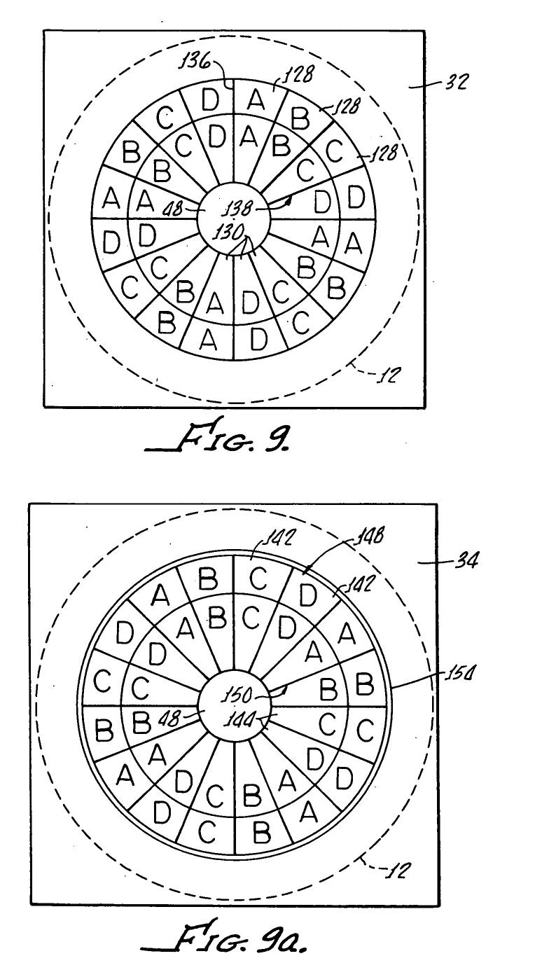

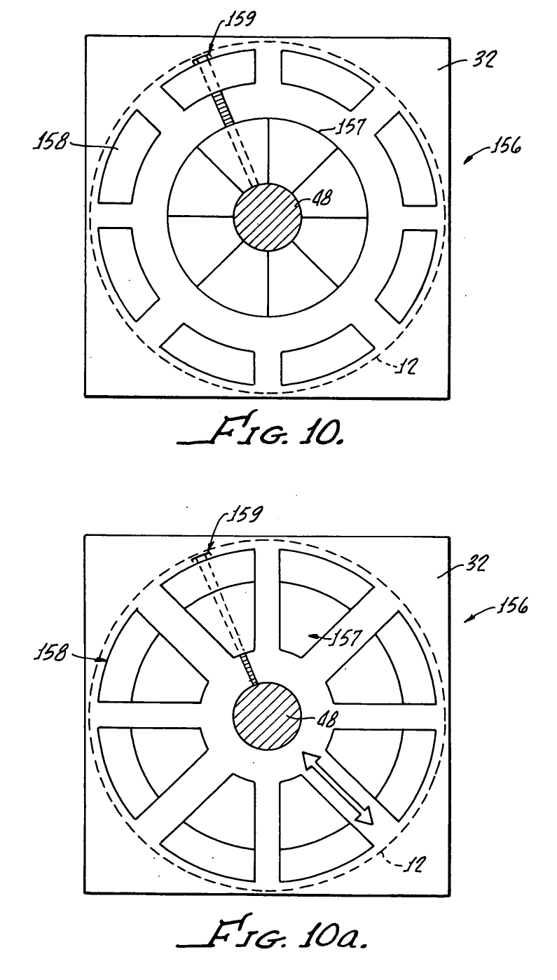

In another embodiment 118 shown in FIGS. 7 and 8, permanent magnets 122 are slidably mounted on the structure 32 along slots 124, only two being shown for clarity, which provide a Structure for moving the permanent magnets 122 in a radial direction relative to the member axis 48 in order to vary eddy current resistance opposing rotation of the member 12.

As illustrated in FIGS. 7 and 8, the braking force on the member 12 can be increased or decreased by positioning the arrays radially along the face of the structure 32, thus altering the distance between the arrays and the rotation of center, or shaft, 48, thus changing torque and changing braking force. As with the previously described embodiments, the full extent of motion of the magnet arrays can be designed to coincide with any desired rotational speed for achieving precise performance of the braking device 10. While shown as being movable along slots 124, or any other appropriate mechanism, such as screws, spokes, wedges, cranks, air or hydraulic pistons, centripetal force, magnetic force, or any other type of mechanism may be utilized to provide the structure 32 for moving the magnets 122 in a radial direction.

FIGS. 9 and 9a show a rotational, or polar off-set of radially shaped magnets 128, 130 disposed in concentric patterns 136, 138 about the shaft 48 on the structure 32 while magnets 142, 144 are disposed in concentric patterns 148, 150 on structure 34. This structure shows the rotational off-set of radially shaped magnets for adjusting braking force by rotating corresponding magnets on the opposing structures 32, 34, out of magnetic alignment, or phase, with one another, thus reducing magnetic field strength and subsequent braking power.

One array of magnets, 128, 130 are represented by the letters A, B, C, D for an array consisting of four magnets in a particular plurality arrangement. A corresponding array on the opposite structure 34 establishes the necessary flux field across the space 84, see FIG. 3.

The letters do not represent any particular pole face for this illustration, but are meant to clarify the principal of alignment which is valid for any number of array configurations.

For this illustration, like letters positioned in the same location on each structure would be considered as being aligned for the sake of this discussion. That is, A on structure 34 is opposite A on the structure 32 and D on 34 is opposite D on 32. The alignment of A to A on one structure applies to only two rows of magnets are present in this embodiment. A rotatable bracket 154 may be utilized to rotate one or more rows of the magnets in and out of alignment with one another.

An alternative embodiment 156 is similar to the embodiment shown in FIGS. 9 and 9a with inner and outer rows 157, 158 radially adjustable by a screw mechanism 159, only one being shown for clarity, as indicated by an arrow A.

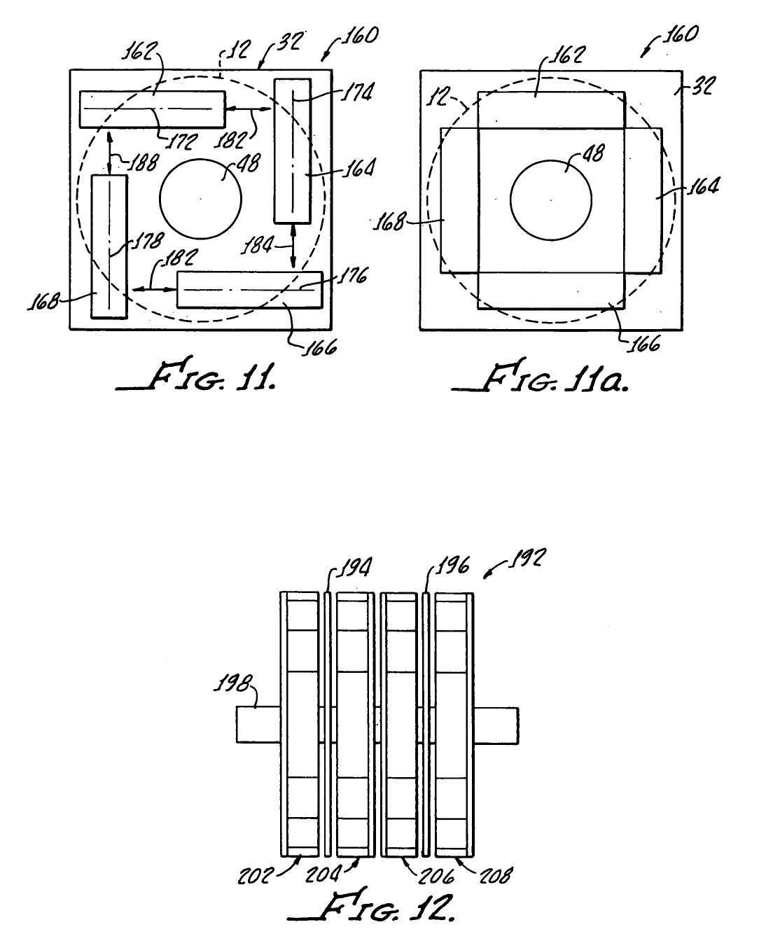

With reference to FIGS. 11 and 11a there is shown an alternative embodiment 160. The magnet 162, 164, 166, 168 configuration in which the magnets 162, 164, 166, 168 are movable along the longitudinal axes 172, 174, 176, 178 as indicated by arrows 182, 184, 186, 188 which provides structure for varying the magnetic coupling between the magnets 162, 164, 166, 168 and a member 12 in order to vary eddy current resistance opposing rotation of the member 12. The magnets 162, 164, 166, 168 may be slidably mounted on the frame 32 in any conventional manner.

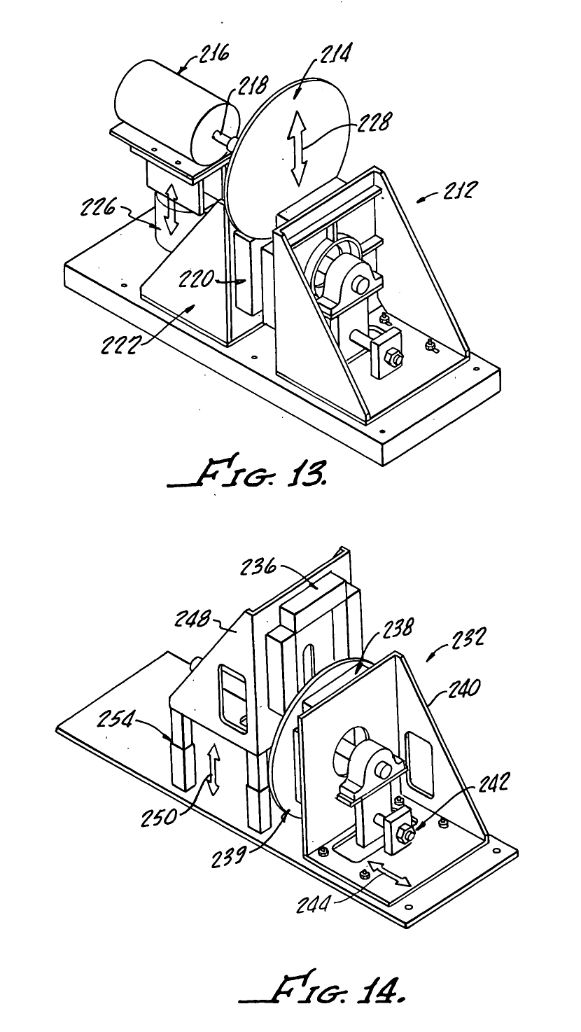

FIG. 12 illustrates another embodiment 192 in accordance with the present invention utilizing multiple members 194, 196 mounted on a shaft 198 with the plurality of magnets 202, 204, 206, 208 of any of the hereinbefore described configurations and supported by a frame, not shown, similar to the frame of 32 hereinabove described.

A further embodiment 212 is shown in FIG. 13 which generally includes a rotatable conductive reaction member 214 mounted to a driving device 216 (shown for illustration and not part of the invention) via a shaft 218 along with magnets 220 disposed on a structure 222, a conventional pneumatic or mechanical lift provides structure for moving the member 214 in a direction parallel to a plane of the member 214 as indicated by the arrow 228 in order to vary the magnetic coupling between the magnets 220 and the member 214 in order to vary eddy current resistant opposing rotation of the member 214.

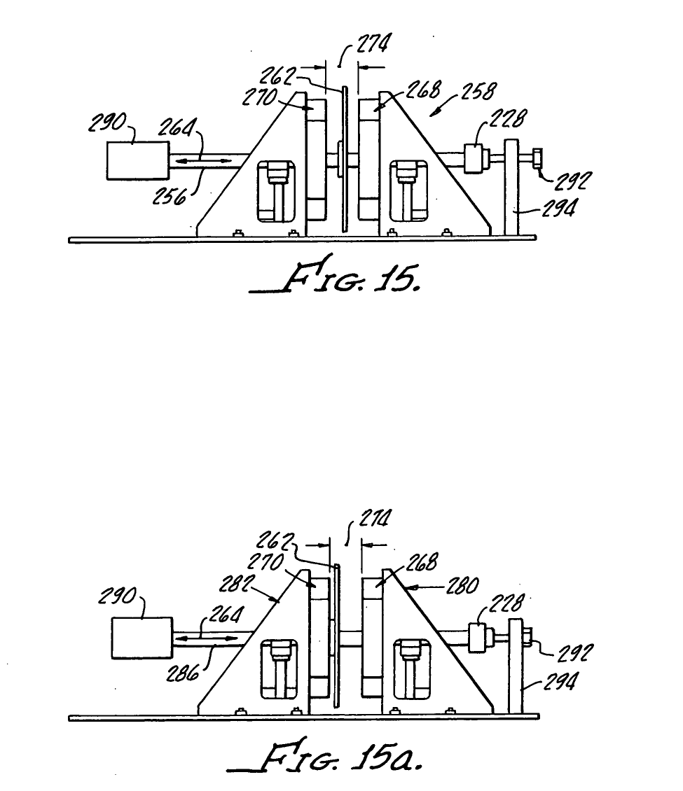

FIG. 14 illustrates yet another embodiment 232 in accordance with the present invention generally including a rotatable conductive reaction member 234 and a plurality of permanent magnets 236, 238 disposed adjacent the member 234 with the magnets 238 being disposed on a frame 240 including an adjustment bolt 242 for movement of the frame 240 and magnets 238 as indicated by the arrow 244 as hereinbefore described.

Embodiment 232 further includes a frame 248 for supporting the magnets 236 with the frame 248 being movable in a plane parallel to the member as indicated by the arrow 250, mechanical or pneumatic extendable posts 254 providing structure for varying the magnetic coupling between the plurality of magnets 236 and the member 238 in order to vary eddy current resistance opposing rotation of the member 238. The adjustable post may be of any conventional design.

With reference to FIGS. 15 and 15a, there is shown an embodiment 258 in accordance with the present invention which includes a member 262 which is movable in a direction perpendicular to a plane of the member 262 as indicated by the arrow 264 in order to vary magnetic coupling between permanent magnet arrays 268, 270 within a gap 274 between the arrays 268, 270. The magnet arrays 268, 270 are disposed on support frames 280, 282. Movement of the member 262 along with a shaft 286 may be accomplished by any suitable actuator 290. A shaft end 292 supported by a station 294 may include a thrust bearing 298 for rotatably supporting the shaft 286 in a conventional manner.

The magnets and arrays have been depicted herein with specific shape for illustrative purpose only. Any suitable shape such as squares, cubes, or wedges may also be used to advantage.

Although there has been hereinabove described a specific axial rotary eddy current brake with adjustable braking force in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for moving the plurality of permanent magnets in a direction perpendicular to a plane of the member.

2. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for moving the plurality of permanent magnets in a direction parallel to a plane of the member.

3. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for moving the plurality of permanent magnets in a radial direction relative to a member axis.

4. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for rotatably adjusting the plurality of permanent magnets to cause magnetic fields, associated with each magnet, to be out of magnetic phase with one another.

5. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for radially adjusting the plurality of permanent magnets to cause magnetic fields, association with each magnet, to be out of phase with one another.

6. The device according to any one of claims 1 to 5 wherein the plurality of permanent magnets are arranged in a Halbach array.

7. The device according to any one of claims 1 to 5 wherein the reaction member is a bladed disk.

8. An adjustable rotary brake device comprising:
at least one rotatable conductive reaction member, said member being comprised of concentric rings of different materials having different electrical conduction in order to alter the eddy current resistance;
a plurality of permanent magnets disposed adjacent the member; and
structure for varying magnetic coupling between the plurality of permanent magnets and the member in order to vary eddy current resistance opposing rotation of the member.

9. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for moving the member in a direction perpendicular to a plane of the member.

10. An adjustable rotary brake device comprising:
at least one rotatable conductive reaction member;
a plurality of permanent magnets disposed adjacent the member; and
structure for varying magnetic coupling between the plurality of permanent magnets and the member in order to vary eddy current resistance opposing rotation of the member, said structure comprising apparatus for moving the member in a direction parallel to a plane of the member.

11. An adjustable rotary brake device comprising:
a rotatable conductive reaction member;
a first plurality of permanent magnets disposed adjacent one side of the member;
a second plurality of permanent magnet disposed adjacent another side of the member; and
structure for varying magnetic coupling between the first and second plurality of permanent magnets and the member in order to vary eddy current resistance opposing rotation of the member.

12. The device according to claim 11 wherein the structure comprises apparatus for moving at least one of the first and second plurality of permanent magnets or individual magnets in a direction perpendicular to a plane of the member.

13. The device according to claim 11 wherein the structure comprises apparatus for moving at least one of the first and second plurality of permanent magnets or individual magnets in a direction parallel to a plane of the member.

14. The device according to claim 11 wherein the structure comprises apparatus for moving at least one of the first and second pluralities of permanent magnets or individual magnets in a radial direction relative to a member rotation axis.

15. The device according to claim 11 wherein the structure comprises apparatus for rotatably adjusting at least one of the first and second pluralities of permanent magnets to cause magnetic fields, association with each magnet, to be out of magnetic phase with one another.

16. The device according to claim 11 wherein the structure comprises apparatus for radially adjusting at least one of the plurality of permanent magnets to cause magnetic fields, associated with each magnet, to be out of magnetic phase with one another.

17. The device according to any one of claims 11-16 wherein the first and second pluralities of permanent magnets are arranged in a Halbach array or Halbach variation.

18. The device according to any one of claims 11-16 wherein the reaction member is a bladed disk.

19. The device according to any one of claims 11-18 wherein the structure comprises apparatus for moving the member in a direction perpendicular to a plane of the member.

20. The device according to any one of claims 11-18 wherein the structure comprises apparatus for moving the member in a direction parallel to a plane of the member.

21. The adjustable rotary brake device comprising:
at least one rotatable conductive reaction member;
a plurality of permanent magnets disposed adjacent the member and rotatable about a member axis; and
structure for varying magnetic coupling between the plurality of permanent magnets and the member in order to vary eddy current resistance opposing rotation of the permanent magnets.

22. The device according to claim 21 wherein the structure comprises varying a speed of rotation of the permanent magnets about the axis.

23. An adjustable rotary brake comprising:
multiple parallel rotatable conductive reaction members, outside members having opposing sides;
a first plurality of permanent magnets disposed adjacent one opposing side;
a second plurality of permanent magnets disposed adjacent another opposing side; and
structure for varying magnetic coupling between the first and second plurality of permanent magnets in order to vary eddy current resistance opposing rotation of the members.

24. A method for providing a variable torque through a range of rotational speeds without an electrical control apparatus in a brake device, the method comprising:
providing at least one rotatable conductive reaction member with a plurality of permanent magnets disposed adjacent the member; and
varying magnetic coupling between the magnet and the member in order to vary eddy current resistance opposing rotation of the member.

25. The method according to claim 24 wherein varying magnetic coupling includes moving the magnets in a direction perpendicular to a plane of the member.

26. The method according to claim 24 wherein varying magnetic coupling includes moving the magnets in a direction perpendicular to the plane of the member.

27. The method according to claim 24 wherein varying magnetic coupling includes moving the magnets in a radial direction relative to a member axis.

28. The method according to claim 24 wherein varying magnetic coupling includes changing a phase relationship of the magnets.

29. The method according to claim 24 wherein varying magnetic coupling includes moving the member in a direction perpendicular to a plane of the member.

30. The method according to claim 24 wherein varying magnetic coupling includes moving the member in a direction parallel to a plane of the member.
